(19) United States
(12) Patent Application Publication
(10) Pub. No.: US 2004/0259518 A1
(43) Pub. Date: Dec. 23, 2004

(54) Multi standard transceiver architecture for wlan

(76) Inventors: Adem Aktas, Columbus, OH (US); Kishore Rama, San Diego, CA (US); James Wilson, Columbus, OH (US)

Correspondence Address: HARNESS, DICKEY & PIERCE, P.L.C., P.O. BOX 8910, RESTON, VA, 20195, US

(21) Appl. No.: 10/478,467

(22) PCT Filed: Jul. 18, 2002
(86) PCT No.: PCT/SE02/01400

(30) Foreign Application Priority Data
Jul. 18, 2001 (SE) 0102554-3

(51) Int. Cl. H04B 1/26

(52) U.S. Cl. 455/323

(57) ABSTRACT

The present invention relates to a radio front end transceiver and methods of operating the transceiver. A transceiver is employed consisting of a first and second receive path and a first and second transmit path. Each first path and second path can handle signals of a first and a second modulation format and a first and a second radio frequency band respectively. The transceiver comprises circuitry for conversion between the respective radio frequency bands and an intermediate frequency. The transceiver is arranged with intermediate frequency circuitry for conversion between the respective intermediate frequencies and basebands. At least some of the intermediate frequency circuitry is common to both receive paths and at least some of the intermediate frequency circuitry is common to both transmit paths. A frequency synthesizer is arranged to derive overlapping local oscillator frequencies suitable for use by the intermediate frequency circuitry on each of the paths.

### TECHNICAL FIELD OF THE INVENTION

The present invention relates to a radio front end transceiver and methods of operating said radio front end transceiver.

### BACKGROUND ART

Local area networks (LANs) are being deployed extensively worldwide using a well-established copper-cable infrastructure. Wireless local area networks (WLANs) have become available as well as other emerging wireless applications in Instrumentation, Scientific and Medical (ISM) bands, including Bluetooth and HomeRF. The initial WLAN applications have used an unlicensed 2.4 GHz ISM band. The 2.4 GHz ISM band has been used for standards including cordless phones, Bluetooth, HomeRF and microwave oven in addition to WLAN. The 2.4 GHz band is heavily occupied with the other standards, which causes great interference leading to slower data rate for WLAN. An unused 5 GHz band also exists, which is cleaner and has more bandwidth to accommodate higher data throughput. There will be need to move to the 5 GHz band in the near future with increasing demand for higher data rate and with increased occupation of the 2.4 GHz ISM band with the deployment of Bluetooth and other applications. However, this transition will not occur overnight and therefore a problem is that during the transition, WLANs must be able to handle both of the above mentioned frequency bands.

### SUMMARY OF INVENTION

An object of the present invention is thus to attain a method and apparatus by which it is possible to implement a transceiver architecture for smooth transition from existing 2.4 GHz WLAN systems to 5 GHz WLAN systems.

This object is achieved by a radio front end transceiver according to claim 1 and a method of operating said radio front end transceiver according to claim 13 and 14. Preferred embodiments are defined by the dependent claims.

According to a first aspect of the invention, a radio front end transceiver is provided comprising a first receive path arranged to receive signals of a first modulation format at a first radio frequency band and a second receive path arranged to receive signals of a second different modulation format at a second different radio frequency band. A first transmit path is arranged to transmit signals of the first modulation format and the first radio frequency band and a second transmit path is arranged to transmit signals of the second modulation format and the second radio frequency band. The radio front end transceiver further comprises circuitry for conversion between the respective radio frequency bands and an intermediate frequency provided in each of the paths. Intermediate frequency circuitry is arranged for conversion between the respective intermediate frequencies and basebands provided in each of the paths, wherein at least some of the intermediate frequency circuitry is common to both receive paths and at least some of the intermediate frequency circuitry is common to both transmit paths. The intermediate frequency circuitry comprises dual band mixers. Also, a frequency synthesizer is arranged to derive local oscillator frequencies suitable for use by the intermediate frequency circuitry on each of the paths and wherein the transmit and receive local oscillator frequencies are arranged to overlap.

According to a second aspect of the invention, a method of operating the radio front end transceiver is provided. The method comprises the steps of receiving radio signals, converting the radio signals to signals at an intermediate frequency band and converting the intermediate frequency band signals to baseband signals.

According to a third aspect of the invention, a method of operating the radio front end transceiver is provided. The method comprises the steps of obtaining baseband signals, converting the baseband signals to an intermediate frequency band and converting the intermediate frequency band signals to radio signals and transmitting the radio signals.

The invention is based on the idea that a radio front end transceiver is employed consisting of a first and second receive path and a first and second transmit path. Each first path can handle signals of a first modulation format and a first radio frequency band. Each second path can handle signals of a second modulation format and a second radio frequency band. The transceiver also comprises circuitry for conversion between the respective radio frequency bands and an intermediate frequency provided in each of the paths. Further, the transceiver is arranged with intermediate frequency circuitry for conversion between the respective intermediate frequencies and basebands provided in each of the paths. At least some of the intermediate frequency circuitry is common to both receive paths and at least some of the intermediate frequency circuitry is common to both transmit paths. The intermediate frequency circuitry comprises dual band mixers. A frequency synthesizer is arranged to derive local oscillator frequencies suitable for use by the intermediate frequency circuitry on each of the paths. These transmit and receive local oscillator frequencies are arranged to overlap.

A frequency plan for this architecture is chosen such that the frequency synthesizers are shared by the transmitter and the receiver. As will be clear from the following description, hardware reuse is an important aspect of the present invention.

The transceiver according to the invention also provides image-rejection by means of proper frequency planning.

By utilizing the radio front end transceiver according to the invention, it is possible to implement a transceiver architecture with a maximum of hardware share to minimize power consumption, die area and manufacturing cost for smooth transition from existing 2.4 GHz WLAN systems to 5 GHz WLAN systems.

According to an embodiment of the invention, a radio frequency synthesizer is arranged to utilize fixed local oscillator frequencies to convert signals in the radio frequency bands to overlapping intermediate frequency bands in the receive paths. The radio frequency synthesizer is implemented by means of a digital phase locked loop. The digital phase locked loop has a programmable divider to select the required local oscillator frequency for the desired radio frequency band. The radio frequency synthesizer is also utilized for the transmitter paths to up convert the intermediate frequency bands to the desired radio frequency bands. By employing the radio frequency synthesizer in both the receive and transmit paths, hardware share is obtained, the size of the radio front end transceiver can be decreased and the manufacturing cost can be reduced.

According to another embodiment of the invention, an intermediate frequency synthesizer generates local oscillator frequencies with a unit step size to convert a specific channel from the intermediate frequency band to baseband. The intermediate frequency synthesizer is implemented by means of a digital phase locked loop. A programmable divider of the phase locked loop is set to convert the specific channel to baseband. Depending on the standards for which the transceiver according to the invention is to be used, the channel bandwidths will vary. The unit step size of the intermediate frequency synthesizer is chosen in accordance with the bandwidth of the most narrow channel. By employing this type of intermediate frequency synthesizer, the number of intermediate frequency synthesizers used can be reduced. Again, the size of the radio front end transceiver can be decreased and the manufacturing cost can be reduced.

According to further embodiments of the present invention, image-rejection can alternatively be provided by means of antenna filtering, radio frequency band pass filtering, low noise amplifier filtering and radio frequency mixer tuning. The frequency characteristics of low noise amplifiers, commercial radio frequency band pass filters, narrow band antennas and radio frequency mixer circuitry offers image-rejection of the received radio frequency signals. This mitigates the requirements on the mixer structure of the receive paths due to the frequency planning of this architecture. An advantage of employing these components is that the number of mixers in the receive path can be reduced due to the fact that I/Q demodulation is unnecessary. As a consequence, neither is it necessary to match the receiver radio frequency path before I/Q demodulation, nor does the radio frequency mixer have to be quadrature and radio frequency signal routing is reduced. Thus, it is possible to simplify the implementation and reduce power consumption, die area and time to market.

### BRIEF DESCRIPTION OF THE DRAWINGS

Exemplifying embodiments of the invention will be described in greater detail with reference to the accompanying drawings, in which:

FIG. 1 shows the frequency plan of the proposed scheme to achieve tri-band operation according to the invention with minimum hardware overhead;

FIG. 2 shows the channel specifications for the IEEE802.11a, IEEE802.11b and HIPERLAN/2 WLAN standards;

FIG. 3 shows the channel assignment for the IEEE802.11a, IEEE802.1b standards;

FIG. 4 shows a block diagram of a proposed transmitter for tri-band operation according to the invention;

FIG. 5 shows the operation of a simplified image-rejection mixer;

FIG. 6 shows a block diagram of a proposed receiver for tri-band operation according to the invention;

FIG. 7 shows a block diagram of a proposed transceiver for tri-band operation according to the invention and a typical frequency synthesizer employed in the present invention;

FIG. 8 shows a block diagram of an embodiment of a transceiver for tri-band operation according to the invention;

FIG. 9 shows the frequency response of a commercial 2.4 GHz low noise amplifier;

FIG. 10 shows the characteristics of a commercial 2.4 GHz band pass filter;

FIG. 11 shows the frequency response of a commercial 5 GHz low noise amplifier; and

FIG. 12 shows the characteristics of a commercial 5 GHz band pass filter;

### DESCRIPTION OF THE PREFERRED EMBODIMENTS OF THE INVENTION

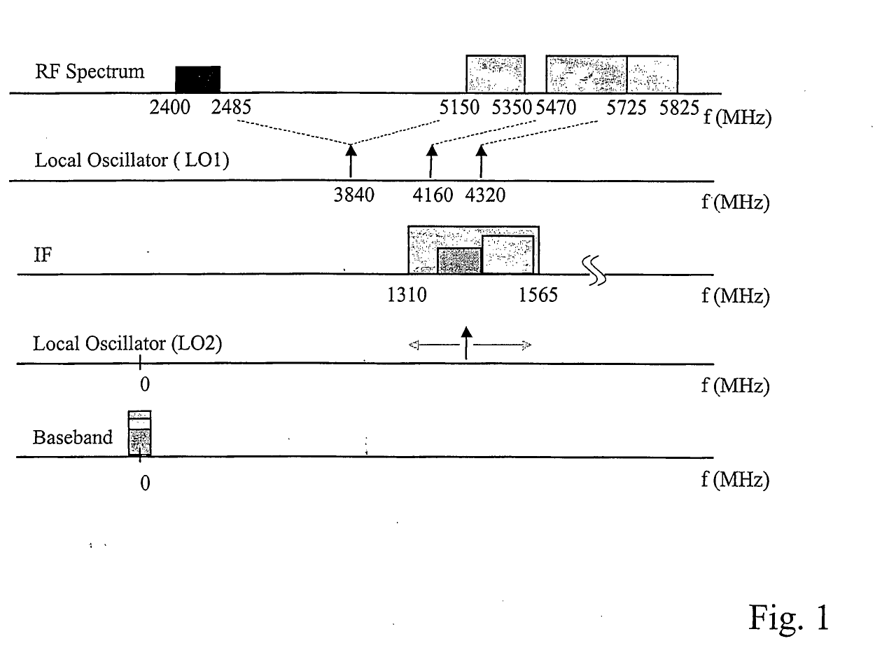

The frequency plan is an important aspect of the architecture according to the present invention. A great deal of hardware reuse leading to lower power consumption and smaller die area is achieved by careful frequency planning. The frequency plan according to FIG. 1 is constructed to cover the currently existing RF bands of the standards mentioned above. Thus, according to an embodiment of the transceiver of the present invention there is provided a tri-band architecture, which is summarized in the following. The first local oscillator has three distinct frequencies, 3840 MHz, 4160 MHz and 4320 MHz, to translate channels from the three RF bands to an IF frequency range between 1310 MHz-1565 MHz. The first LO frequency at 3840 MHz translates channels from 2.4 GHz RF band and 5.15-5.35 GHz RF band to the IF band. The second LO frequency at 4160 MHz translates channels from 5500 MHz-5700 MHz RF band to the IF band. The third LO frequency at 4320 MHz translates channels from 5745-5805 MHz RF band to the IF band. A single IF frequency would produce a wide IF band which would pose great challenges to IF frequency synthesizer design because of very large division ratios in phase-locked loops (PLLs) used to generate local oscillator frequencies. The three LO frequencies should be chosen such that the IF span, in this case 1310 MHz-1565 MHz, is relatively small. This facilitates the operation of the circuits following the down conversion. From FIG. 1, it can be seen that the frequencies of LO1 is chosen such that they are located approximately between the bands. The selection of frequencies for LO1 can be done rather arbitrarily and is not critical as long as the IF bands overlap and image-rejection can be attained. Note that the 5 GHz band consists of two sub bands, one in the range of 5150-5350 MHz and one in the range of 5470-5825 MHz.

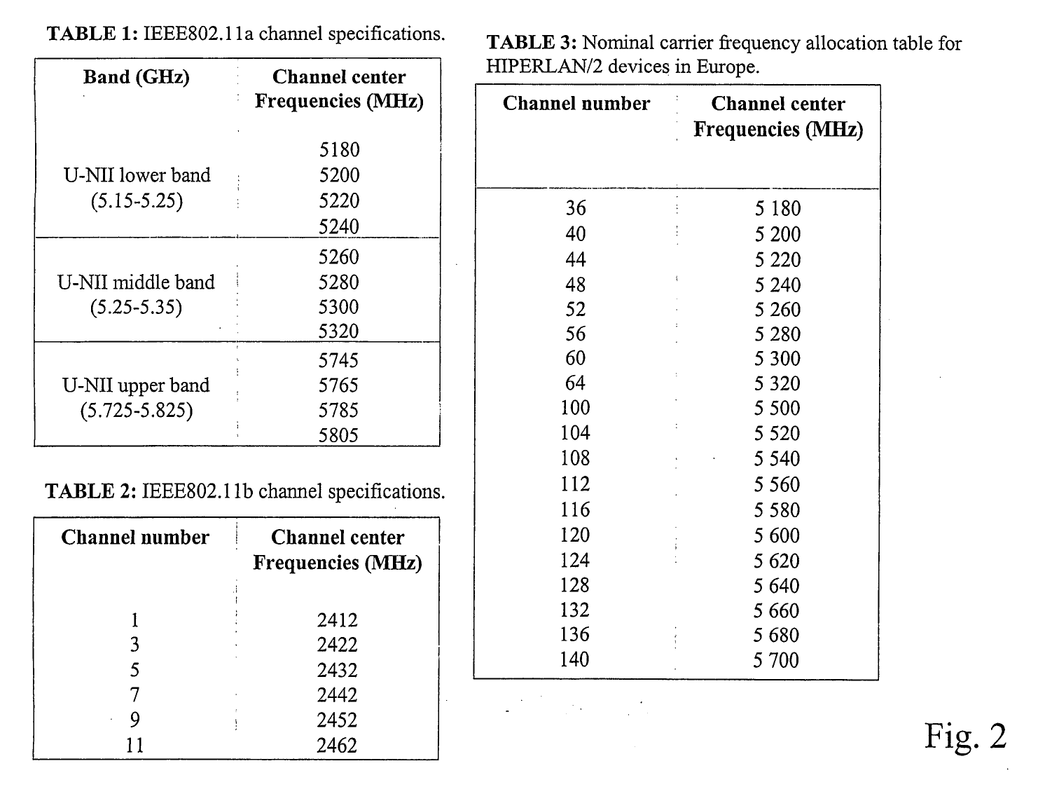

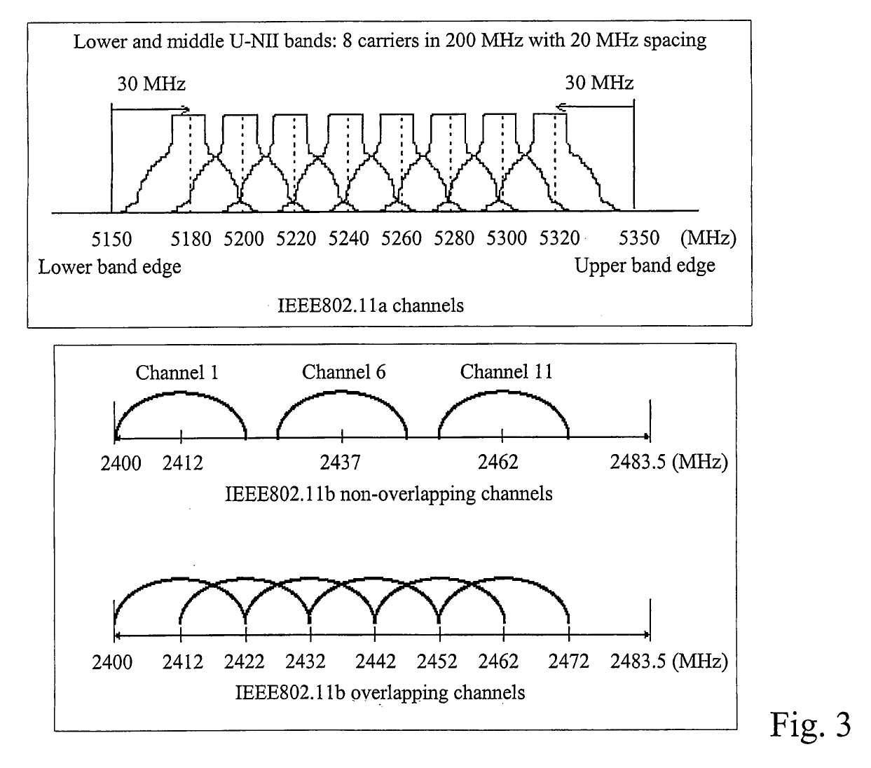

The present invention can advantageously be employed in, for example, the IEEE802.11a, IEEE802.11b, IEEE802.11g and HIPERLAN/2 wireless LAN standards. It should be noted that the present invention in no way is limited to these standards, they are only exemplifying. Channel numbers and corresponding center frequencies of the IEEE802.11a, IEEE802.11b and HIPERLAN/2 standards are shown in FIG. 2. FIG. 3 shows the channel assignment for the IEEE802.11a, IEEE802.11b standards.

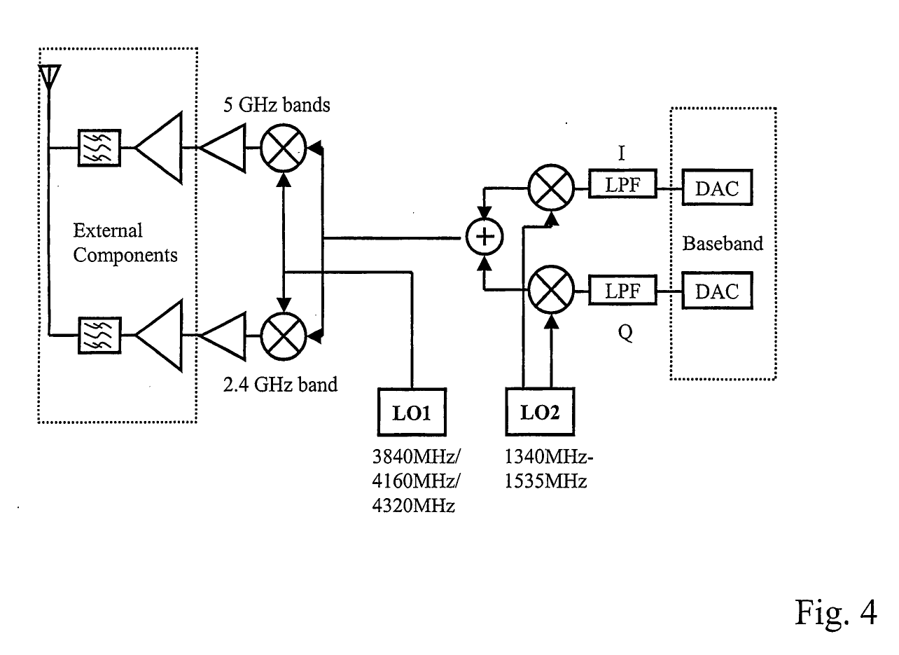

An embodiment of the transmitter according to the invention is shown in FIG. 4, and its operation is rather straightforward. The transmitter uses a two-step up conversion architecture to utilize the same local oscillators (LO) used in the receiver to save die area and power. In phase (I) and quadrature (Q) channels from baseband first passes through low-pass filters LPF to filter out harmonics from the DAC outputs. The second quadrature LO (LO2) is variable in frequency and does channel selection which later will generate any of the center frequencies shown in FIG. 2, under assumption that the invention is operating in the aforementioned standards. The frequency range of L02 is 1340 MHz-1535 MHz. The second mixer output is combined to generate single side-band. The single sideband is up converted to RF carrier levels in their relevant bands (the lowest frequency channel will be centered at 2412 MHz and the highest at 5805 MHz) with three fixed local oscillator frequencies (LO1), i.e. 3840 MHz, 4160 MHz and 4320 MHz. The RF signals from the RF mixer output are fed to an internal power amplifier, which can be either used alone or to drive an external power amplifier.

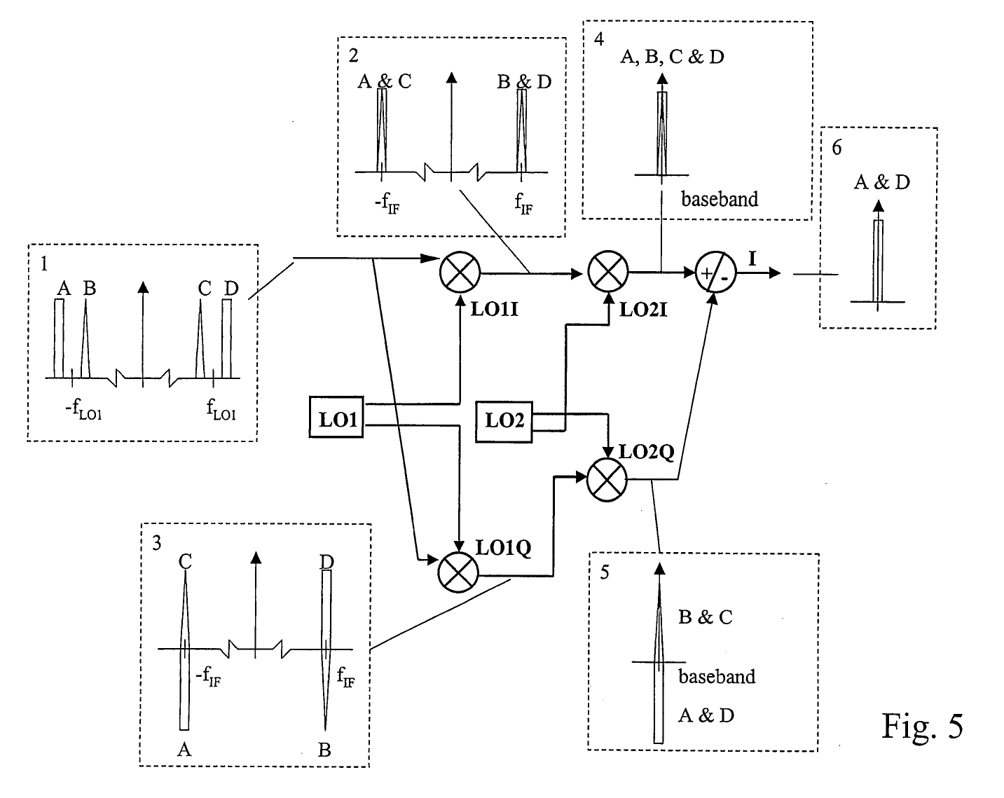

The function of a receiver is to successfully demodulate the desired signal in the presence of strong interference and noise. A receiver can utilize an image-rejection mixer architecture which uses phase shifts in order to cancel out image signals. This eases the requirements on RF filters. The operation of a receiver is more complex than that of a transmitter, and the operation of a simplified image-rejection mixer is described in FIG. 5. At 1, it can be seen that a desired RF signal (A and D) is fed to the mixer. An image signal (B and C) located at an equal distance (IF) on the other side of the local oscillator frequency (LO1) will be converted to the same IF as the desired signal after the first mixer stage. This can be seen at 2 and 3. Clearly, this unwanted image signal must be removed since it is now corrupting the desired signal. Note that this mixing also produces higher frequency products which usually are removed by low-pass filtering. After the second mixer stage, at 4 and 5, it can be seen that both the desired signal and the unwanted image signal has been converted down to baseband. By subtracting the signal at 5 from the signal at 4, the unwanted image signal can be removed. This will result in the signal at 6, i.e. the desired signal has been detected and converted down to baseband. Note that the structure of the mixer is exemplifying only, and shows merely the in phase part of the signal. For quadrature phase detection, two more mixers must be used in the second mixer stage. Filters are also utilized in the mixer architecture.

The embodiment of a receiver architecture according to the invention, as shown in FIG. 5, is capable of tri-band operation. The RF filters each have a pass band of 5150 MHz-5350 MHz and 5470 MHz-5825 MHz (for the 5 GHz band) and 2400 MHz-2480 MHz (for the 2.4 GHz band). In addition to selecting the desired band they provide suppression of the other band as well. The RF front-end of the receiver consists of a low noise amplifier LNA that amplifies the weak RF signal while adding very little noise. It is followed by the down conversion mixer that translates the RF signal to an intermediate frequency (IF). The 5 GHz band and 2.4 GHz band have separate LNAs to optimize the receiver performance. The first mixers have two distinct input ports, one for the 5 GHz band and one for the 2.4 GHz band. This allows for optimal design of each of the two paths in terms of system performance, power consumption and minimized area consumption. The path that operates the unused band at the moment can be switched off to reduce power consumption.

The first local oscillator (LO1) frequency is chosen such that it provides low side injection for the 5 GHz band and high side injection for the 2.4 GHz band. This operation translates the desired RF signal in both the 5 GHz band and the 2.4 GHz band to the same IF band as shown in FIG. 2. Frequencies at 3840 MHz, 4160 MHz, and 4320 MHz for LO1 enables the creation of this IF band. The RF bands will be translated into an IF range around 1400 MHz. A filter is programmed to select the desired band before the second down conversion. This filter is implemented as part of the RF mixer structure, the mixers being tuned to the desired frequency. The inherent narrow band behavior of mixers at their outputs and inputs eliminates additional filtering between the mixer circuitry. When, for example, a 5240 MHz RF signal is down converted with a 3840 MHz LO frequency, the RF mixer will convert the 5240 MHz signal to a 9080 MHz and a 1400 MHz signal. The 1400 MHz signal will appear at the RF mixer output since the mixer is tuned to this frequency range.

The second down conversion performed with the help of the second local oscillator (LO2) facilitates signal processing of the in phase and quadrature (I and Q) signals. As shown in FIG. 5, the signals are combined after the second mixer stage in order to cancel out image signals. LO2 generates the center frequencies of the channels shown in FIG. 2. The selectivity is provided by the low pass filter LPF whose cut-off frequency is programmable to select the desired channel. The output of the LPF is fed to an automatic gain control (AGC) circuit to provide variable gain to achieve a large dynamic range for the receiver. The output of the AGC is converted to digital domain by the analog to digital converter (ADC) for digital signal processing.

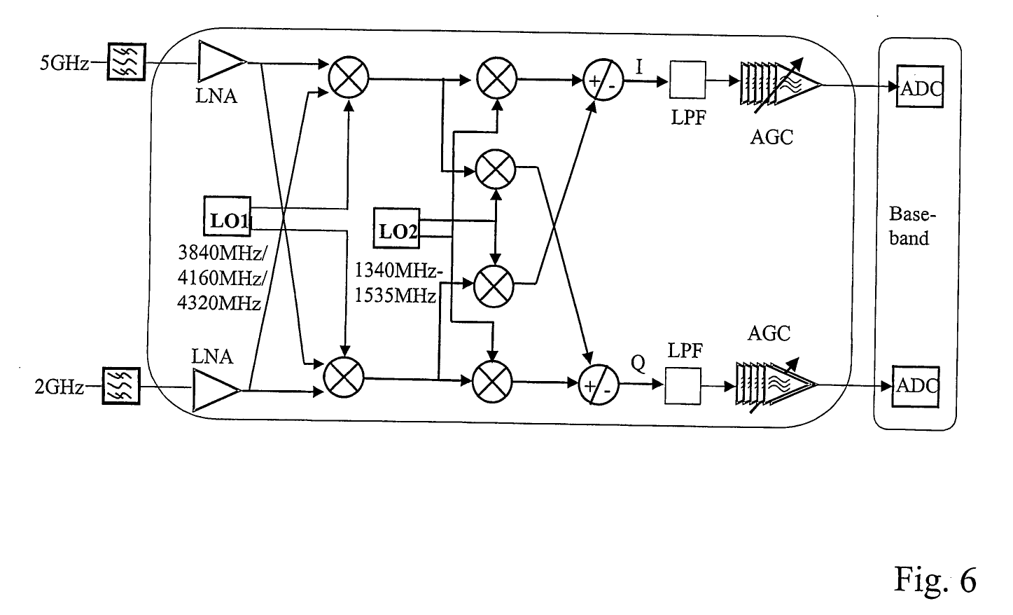

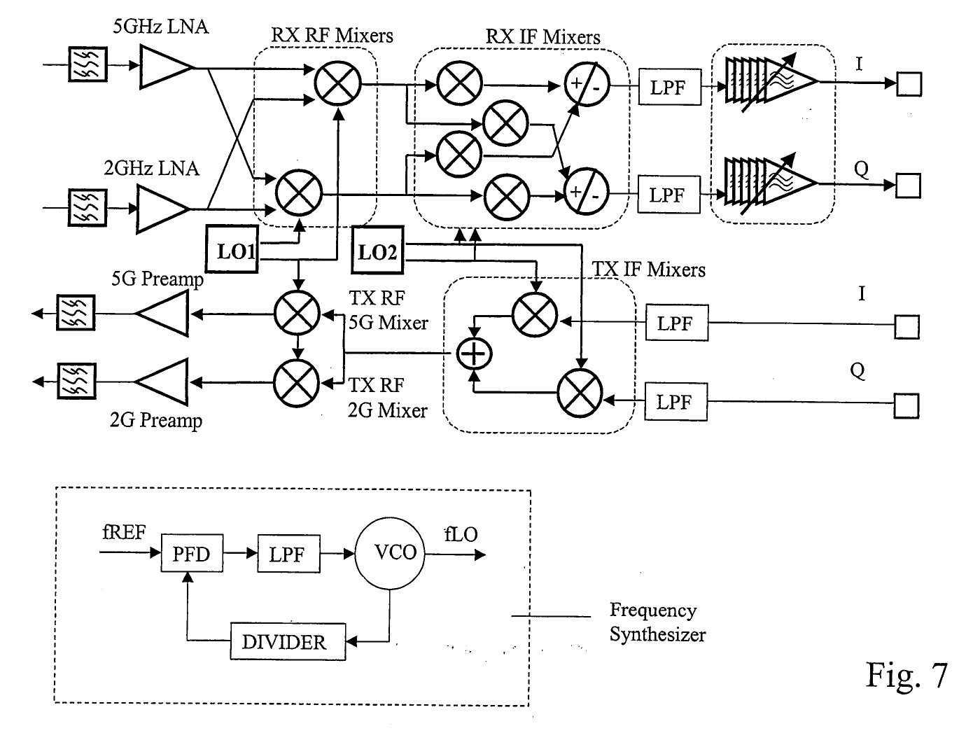

FIG. 7 shows a block diagram of an embodiment of the transceiver for tri-band operation according to the invention. The description for FIG. 7 has been given in connection to FIG. 4 and FIG. 6.

FIG. 7 also shows a standard frequency synthesizer in the form of a digital phase locked loop used in the present invention to generate local oscillator frequencies. It typically comprises a phase-frequency detector PFD, a low pass filter LPF a voltage controlled oscillator VCO and a programmable divider. The digital phase locked loop has a programmable divider to select the required local oscillator frequency. By employing the frequency synthesizer in both the receive and transmit paths, hardware share is obtained, the size of the radio front end transceiver can be decreased and the manufacturing cost can be reduced. The divider can also be arranged to receive control signals related to the input frequency band, thereby controlling the phase locked loop to generate local oscillator frequencies. The frequency synthesizer can also generate local oscillator frequencies with a unit step size to convert a specific channel from the intermediate frequency band to baseband. Depending on the standards for which the transceiver according to the invention is to be used, the channel bandwidths will vary. The unit step size, in this case 1 MHz, of the frequency synthesizer is chosen in accordance with the bandwidth of the most narrow channel. Thus, there is no need to employ a separate frequency synthesizer for each and every different standard. By employing this type of frequency synthesizer, the number of intermediate frequency synthesizers used can be reduced. Again, the size of the radio front end transceiver can be decreased and the manufacturing cost can be reduced.

The architecture for the triple-band (the 2.4 GHz band and the two sub bands comprised in the 5 GHZ band) WLAN application according to the invention entails some implementation difficulties, such as I/Q LO generation at very high frequencies (4 GHZ), I/Q path matching in image-rejection, complexity, high power consumption (I/Q LO generation, several mixers in the image-rejection mixer architecture) and testing difficulties.

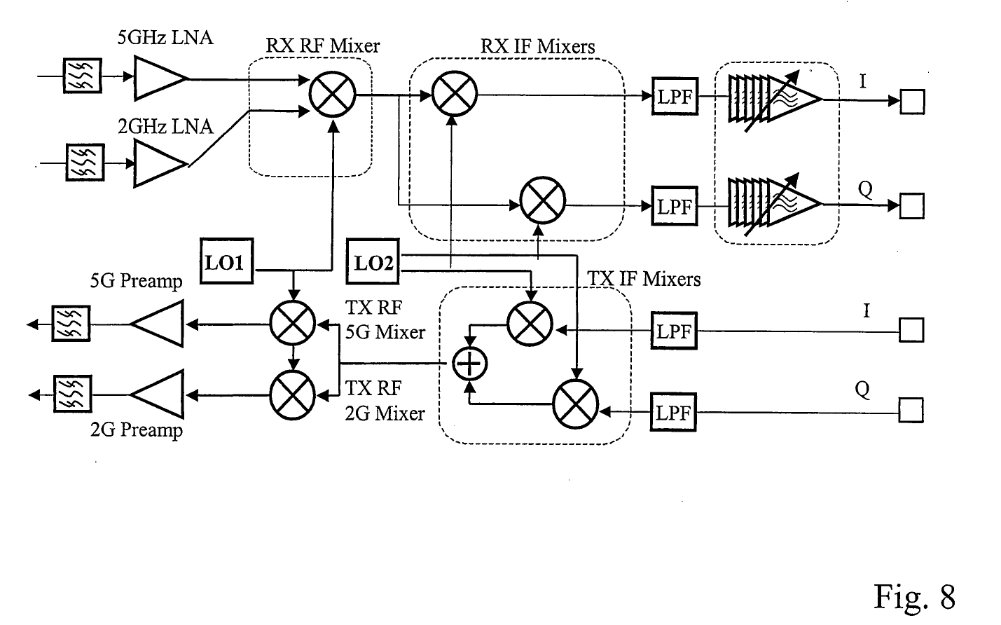

Without an image-rejection receiver architecture, a traditional two-step down conversion architecture as shown in FIG. 8 can alternatively provide image-rejection through antenna and RF band pass filter off-chip and through LNA and RF mixer on-chip. A rough estimation of image rejection for 2.4 GHz and 5 GHz receiver paths without any image rejection scheme, as shown in FIG. 8, is done here.

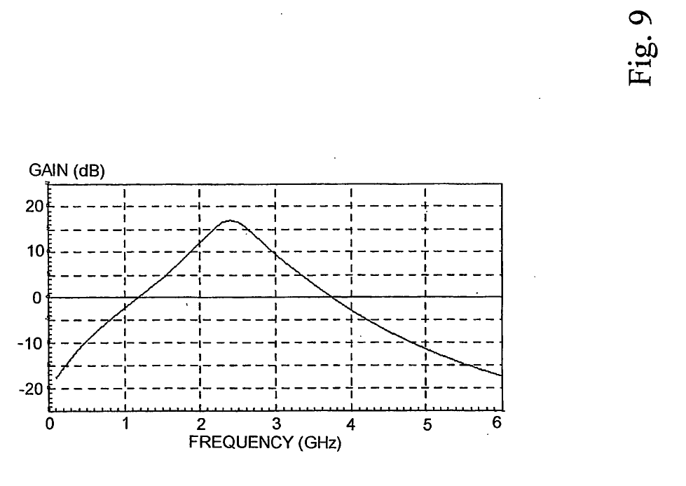

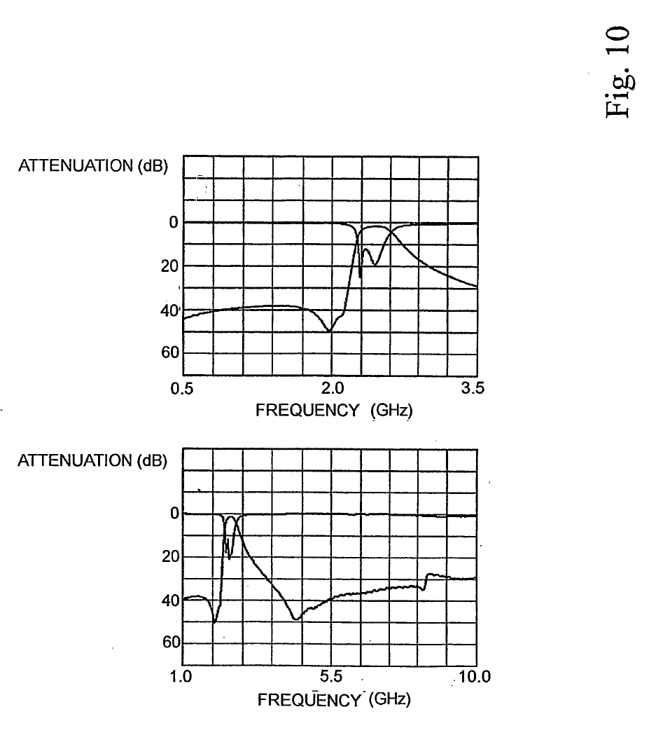

First consider the 2.4 GHz receiver path of FIG. 8. The image band is placed around 5.2-5.3 GHz. The 2.4 GHz LNA frequency response shown in FIG. 9 suggests that an image-rejection of about 30 dB can be achieved. Note that the term “image-rejection” herein is defined as the attenuation of the image band in relation to the corresponding desired band. That is, the gain around 2.4 GHz (i.e. the desired band) is about 17 dB and the gain around 5.2 GHz (i.e. the image band) is about −13 dB, resulting in an image-rejection of 17−(−13)=30 dB. The frequency response of a commercial RF band pass filter for 2.4 GHZ WLAN applications is shown in FIG. 10. An image-rejection of about 42 dB can be obtained from the 2.4 GHz RF BP filter. A total of more than 70 dB of image-rejection can thus be achieved just from the 2.4 GHz RF BP filter and the 2.4 GHz LNA for the frequency plan shown in FIG. 1. Additional image-rejection in the range of 20 dB can be obtained from a narrow band antenna for 2.4 GHz WLAN application and RF mixer. This results in a total of 90 dB of image-rejection without an image-reject receiver scheme using a conventional two-step down conversion architecture instead.

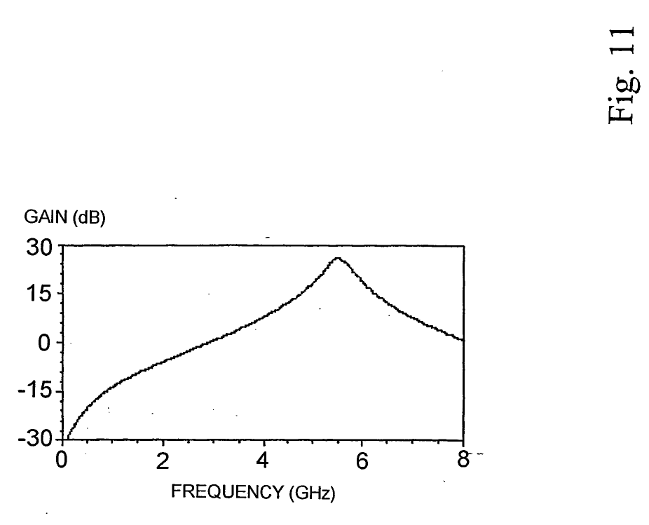

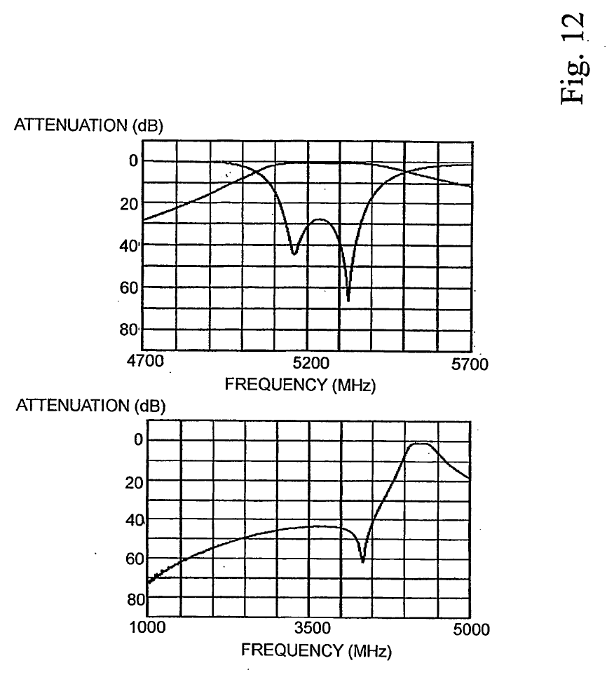

Next consider the 5 GHz receiver path of FIG. 8. The image bands are placed around 2.3-2.5 GHz, 2.6-2.8 GHz and 2.8-2.9 GHz. The 5 GHz LNA frequency response shown in FIG. 11 suggests that an image-rejection of roughly 24 dB for the 2.3-2.5 GHz band, 25 dB for the 2.6-2.8 GHz band and 21 dB for the 2.8-2.9 GHz band can be obtained. The frequency response of a commercial RF band pass filter for 5 GHZ WLAN applications is shown in FIG. 12. An image-rejection of at least 50 dB for the 2.3-2.5 GHz band, at least 40 dB for the 2.6-2.8 GHz band and at least 35 dB for the 2.8-2.9 GHz can be obtained from the 5 GHz RF BP filter. A total of about 55-75 dB of image-rejection can thus be achieved just from the 5 GHz RF BP filter and the 5 GHz LNA for the frequency plan shown in FIG. 1. Additional image-rejection can be obtained from a narrow band antenna for 5 GHz WLAN application and RF mixer. The initial estimation of image-rejection band attenuations from a conventional two-step receiver architecture suggests that the image reject scheme may not be needed. By removing the image reject scheme it is possible to simplify the implementation and reduce power consumption, die area and time to market. Some of the advantages of removing the image reject scheme are listed briefly:

i. The 6 mixers are reduced to 3 mixers in the receiver path.

ii. There is no need to match the receiver RF path before IF I/Q demodulation.

iii. The first LO does not have to be quadrature. This can provide a significant die area saving and power dissipation reduction.

iv. RF signal routing is reduced.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A radio front end transceiver comprising:
a first receive path arranged to receive signals of a first modulation format at a first radio frequency band;
a second receive path arranged to receive signals of a second different modulation format at a second different radio frequency band;
a first transmit path arranged to transmit signals of the first modulation format and the first radio frequency band;
a second transmit path arranged to transmit signals of the second modulation format and the second radio frequency band;
circuitry for conversion between the respective radio frequency bands and an intermediate frequency provided in each of the paths;
intermediate frequency circuitry for conversion between the respective intermediate frequencies and basebands provided in each of the paths, wherein at least some of the intermediate frequency circuitry is common to both receive paths and at least some of the intermediate frequency circuitry is common to both transmit paths; said intermediate frequency circuitry comprising dual band mixers; and
a frequency synthesizer arranged to derive local oscillator frequencies suitable for use by the intermediate frequency circuitry on each of the paths and wherein the transmit and receive local oscillator frequencies are arranged to overlap.

2. The radio front end transceiver according to claim 1, wherein the arranged to generate by the circuitry for radio frequency bands and the intermediate frequency bands, frequency synthesizer is further local oscillator frequencies for converting the signals between the radio frequency bands and the intermediate frequency bands.

3. The radio front end transceiver according to claim 1, wherein the frequency synthesizer in the form of a fixed frequency synthesizer is arranged to generate local oscillator frequencies for the radio frequency to intermediate frequency conversion using a phase-locked loop arranged with a programmable divider, the divider being arranged to receive control signals relating to the input frequency band, thereby controlling the phase locked loop to generate the local oscillator frequencies.

4. The radio front end transceiver according to claim 3, wherein said phase locked loop frequency synthesizer comprises a first local loop which is arranged to derive the local oscillator frequencies for the transmit and receive paths such that those frequencies overlap.

5. The radio front end transceiver according to claim 1, wherein the transceiver comprises a single second local oscillator, wherein in the receive path the required baseband frequency signals are obtained by mixing the intermediate frequency signals with signals derived from integer division of the second local oscillator output.

6. The radio front end transceiver according to claim 1, wherein the first intermediate frequency conversion is performed by circuitry arranged to convert three radio frequency bands to the intermediate frequency band.

7. The radio front end transceiver according to claim 1, wherein the circuitry of the transceiver is arranged to eliminate the filter circuitry between the mixer circuitry.

8. The radio front end transceiver according to claim 1, wherein a narrow band antenna is arranged to provide image-rejection of the received radio frequency signals.

9. The radio front end transceiver according to claim 1, wherein a low noise amplifier is arranged to provide image-rejection of the received radio frequency signals.

10. The radio front end transceiver according to claim 1, wherein a radio frequency band pass filter is arranged to provide image-rejection of the received radio frequency signals.

11. The radio front end transceiver according to claim 1, wherein radio frequency mixer circuitry is arranged to provide image-rejection of the received radio frequency signals.

12. The radio transceiver according to claim 1, wherein in a common first circuit, distinct radio air interface signals are down converted with a first local oscillator, amplified and converted using a second local oscillator, to in-phase and quadrature baseband signals, wherein in a second circuit, distinct baseband modulation format in-phase and quadrature signals are up converted to their respective distinct radio air interface signals in a common circuit configured as a phase locked loop up converting modulator, which uses the first local oscillator common to the first circuit and a frequency reference derived from the second local oscillator, wherein the frequency synthesis is arranged so that only two phase locked voltage controlled oscillators are required, all derived from the same frequency reference for both receiver and transmitter paths.

13. A method of operating a radio front end transceiver as claimed in claim 1, said method comprising the steps of
(i) receiving radio signals;
(ii) converting the radio signals to signals at an intermediate frequency band;
(iii) converting the intermediate frequency band signals to baseband signals.

14. A method of operating a radio front end transceiver as claimed in claim 1 comprising the steps of:
(i) obtaining baseband signals;
(ii) converting the baseband signals to an intermediate frequency band; and
(iii) converting the intermediate frequency band signals to radio signals and transmitting the radio signals.
